(19) United States
(12) Patent Application Publication
(10) Pub. No.: US 2020/0156018 A1
(43) Pub. Date: May 21, 2020

(54) FINE BUBBLE GENERATING METHOD AND FINE BUBBLE GENERATING APPARATUS

(71) Applicant: NANO-SCIENCE LABORATORY CORPORATION, Kyoto-shi, Kyoto (JP)

(72) Inventor: Tsuyoshi KIRIISHI, Yokohama-shi (JP)

(73) Assignee: NANO-SCIENCE LABORATORY CORPORATION, Kyoto-shi, Kyoto (JP)

(21) Appl. No.: 16/615,377

(22) PCT Filed: Apr. 24, 2018
(86) PCT No.: PCT/JP2018/016645

§ 371 Date: Nov. 20, 2019

(51) Int. Cl. B01F 3/04; B01F 11/02; B01F 7/06

(52) U.S. Cl. CPC B01F 3/04262; B01F 3/04588; B01F 3/04978; B01F 2003/04319; B01F 7/06; B01F 2003/0439; B01F 11/0258

(57) ABSTRACT

A fine bubble generating method and apparatus capable of generating fine bubbles having nano-order diameters including a storage tank for storing liquid, a liquid feeding unit for suctioning and feeding the liquid stored in storage tank, a bubble supply unit for supplying bubbles into the liquid which is being fed by liquid feeding unit, and a storage tank for storing the liquid into which bubbles have been supplied by bubble supply unit. Pure water is introduced into storage tank, a liquid feeding pump of the liquid feeding unit is actuated, and air is discharged from a gas discharge head of type A in a bubble supply portion while pure water in storage tank is fed to the bubble supply portion, whereby bubbles are supplied into the pure water passing through bubble supply portion in a turbulent state, and the pure water containing bubbles is fed into storage tank and stored.

### TECHNICAL FIELD

The present invention relates to a fine bubble generating method and a fine bubble generating apparatus for generating, in liquid, fine bubbles having nano-order diameters.

### BACKGROUND ART

A method for generating fine bubbles in liquid is disclosed in, for example, Patent Literature 1. In the fine bubble generating method, a porous body which has multiple gas discharge pores having pore diameters of 5 μm is immersed in liquid stored in a storage tank, and gas is discharged from the porous body, to supply bubbles into the liquid, and vibration having a frequency of 1 kHz or less is applied to the porous body in the direction that is almost perpendicular to the bubble discharging direction while the bubbles are being supplied into the liquid. When the vibration having a frequency of 1 kHz or less is applied to the porous body in the direction that is almost perpendicular to the bubble discharging direction, bubbles discharged from the porous body are made fine by a shear force, to generate fine bubbles in the liquid.

### CITATION LIST

### Patent Literature

[PTL 1] Japanese Laid-Open Patent Publication No. 2003-93858

### SUMMARY OF THE INVENTION

### Problems to be Solved by the Invention

However, in the fine bubble generating method disclosed in Patent Literature 1, since the pore diameter of the gas discharge pore of the porous body for supplying bubbles is 5 μm and is relatively large, fine bubbles (microbubbles) having bubble diameters of about a hundred and several tens of μm to about several hundred μm can be generated but fine bubbles having nano-order bubble diameters cannot be generated.

It is said that, by bubbles which are stabilized to have a perfectly spherical shape and which have bubble diameters of 1.5 μm or less being generated in liquid, while the bubbles are self-contracting, the bubbles are made fine as nano-order bubbles having bubble diameters of several hundred nm to several nm. However, the bubbles which have been just generated have unstable non-perfectly spherical shapes, and the bubbles contact with each other due to Brownian motion, and are easily combined and enlarged. Therefore, nano-order bubbles cannot be efficiently generated merely by generating, in liquid, bubbles having bubble diameters of 1.5 μm or less.

An object of the present invention is to provide a fine bubble generating method and a fine bubble generating apparatus capable of efficiently generating, in liquid, fine bubbles having nano-order diameters.

### Solution to the Problems

In order to solve the aforementioned problem, the invention of claim 1 is directed to a fine bubble generating method for generating, in liquid, fine bubbles having nano-order diameters, and the fine bubble generating method includes supplying bubbles into the liquid by discharging gas from a gas discharge head that has multiple gas discharge pores having pore diameters of 1.5 μm or less, and inhibiting the bubbles from colliding with each other.

According to the invention of claim 2, in the fine bubble generating method according to the invention of claim 1, a liquid flow is formed into a turbulence while bubbles are supplied into the liquid flow, or bubbles are supplied into a liquid flow while the liquid flow is formed into a turbulence, to inhibit the bubbles from colliding with each other.

According to the invention of claim 3, in the fine bubble generating method according to the invention of claim 1, a liquid flow is formed into an eddy flow while bubbles are supplied into the liquid flow, or bubbles are supplied into a liquid flow while the liquid flow is formed into an eddy flow, to inhibit the bubbles from colliding with each other.

According to the invention of claim 4, in the fine bubble generating method according to the invention of claim 1, bubbles are supplied into a stationary liquid while vibration having an amplitude of 0.1 μm or greater is continuously applied to the stationary liquid, or vibration having an amplitude of 0.1 μm or greater is continuously applied to a stationary liquid while bubbles are supplied into the stationary liquid, to inhibit the bubbles from colliding with each other.

According to the invention of claim 5, in the fine bubble generating method according to the invention of claim 1, bubbles are supplied into a liquid flow while vibration having an amplitude of 0.1 μm or greater is continuously applied to the liquid flow, or vibration having an amplitude of 0.1 μm or greater is continuously applied to a liquid flow while bubbles are supplied into the liquid flow, to inhibit the bubbles from colliding with each other.

When the fine bubble generating method according to the invention of claim 2, 3, or 5 is used, the gas discharge velocity at each gas discharge pore of the gas discharge head is preferably adjusted so as to satisfy the following formula (1).

v_{G}≤0.087×Q_{L}×D_{H}³/A_{H} (1)
v_{G}: gas discharge velocity [m/s] at gas discharge pore of gas discharge head
Q_{L}: liquid flow rate [L/min]
D_{H}: average pore diameter [μm] of gas discharge pore of gas discharge head
A_{H}: total area [cm²] of all gas discharge pores of gas discharge head

When the fine bubble generating method according to the invention of claim 4 is used, the gas discharge velocity at each gas discharge pore of the gas discharge head is preferably adjusted so as to satisfy the following formula (2).

v_{G}≤0.087×V_{L}/t×D_{H}³/A_{H} (2)
v_{G}: gas discharge velocity [m/s] at gas discharge pore of gas discharge head
V_{L}: liquid amount [L]
t: time [s] when gas is discharged from gas discharge pore of gas discharge head
D_{H}: average pore diameter [μm] of gas discharge pore of gas discharge head
A_{H}: total area [cm²] of all gas discharge pores of gas discharge head

In order to solve the aforementioned problem, the invention of claim 6 is directed to a fine bubble generating apparatus for generating, in liquid, fine bubbles having nano-order diameters, and the fine bubble generating apparatus includes: a bubble supply unit configured to supply bubbles into liquid; and a bubble collision inhibiting unit configured to inhibit the bubbles supplied into the liquid by the bubble supply unit from colliding with each other. The bubble supply unit has a gas discharge head which is immersed in the liquid and has gas discharge pores having sizes of 1.5 μm or less.

According to the invention of claim 7, in the fine bubble generating apparatus according to the invention of claim 6, the bubble supply unit supplies bubbles to a liquid flow in a flow channel, the bubble collision inhibiting unit has a turbulence forming portion that forms the liquid flow in the flow channel into a turbulence, and the turbulence forming portion forms, while bubbles are supplied into a liquid flow from the gas discharge head, the liquid flow into a turbulence, or bubbles are supplied into a liquid flow from the gas discharge head while the turbulence forming portion forms the liquid flow into a turbulence, to inhibit the bubbles from colliding with each other.

According to the invention of claim 8, in the fine bubble generating apparatus according to the invention of claim 6, the bubble supply unit supplies bubbles into a liquid flow in a flow channel, the bubble collision inhibiting unit has an eddy flow forming portion that forms the liquid flow in the flow channel into an eddy flow, and the eddy flow forming portion forms, while bubbles are supplied into a liquid flow from the gas discharge head, the liquid flow into an eddy flow, or bubbles are supplied into a liquid flow from the gas discharge head while the eddy flow forming portion forms the liquid flow into an eddy flow, to inhibit the bubbles from colliding with each other.

According to the invention of claim 9, in the fine bubble generating apparatus according to the invention of claim 6, the bubble supply unit supplies bubbles into a stationary liquid stored in a storage tank unit, the bubble collision inhibiting unit has a vibrator for continuously applying vibration having an amplitude of 0.1 μm or greater, to the stationary liquid stored in the storage tank unit, and the vibrator continuously applies, while bubbles are supplied into a stationary liquid from the gas discharge head, vibration having an amplitude of 0.1 μm or greater to the stationary liquid, or bubbles are supplied into a stationary liquid from the gas discharge head while the vibrator continuously applies vibration having an amplitude of 0.1 μm or greater to the stationary liquid, to inhibit the bubbles from colliding with each other.

According to the invention of claim 10, in the fine bubble generating apparatus according to the invention of claim 6, the bubble supply unit supplies bubbles into a liquid flow, the bubble collision inhibiting unit has a vibrator for continuously applying vibration having an amplitude of 0.1 μm or greater to the liquid flow, and the vibrator continuously applies, while bubbles are supplied into a liquid flow from the gas discharge head, vibration having an amplitude of 0.1 μm or greater to the liquid flow, or bubbles are supplied into a liquid flow from the gas discharge head while the vibrator continuously applies vibration having an amplitude of 0.1 μm or greater to the liquid flow, to inhibit the bubbles from colliding with each other.

When the fine bubble generating apparatus according to the invention of claim 7, 8, or 10, is used, the gas discharge velocity at each gas discharge pore of the gas discharge head is preferably adjusted so as to satisfy formula (1) described above. When the fine bubble generating apparatus according to the invention of claim 9, is used, the gas discharge velocity at each gas discharge pore of the gas discharge head is preferably adjusted so as to satisfy formula (2) described above.

### Advantageous Effects of the Invention

As described above, in the fine bubble generating method according to the invention of claim 1 and the fine bubble generating apparatus according to the invention of claim 6, non-perfectly spherical bubbles having been just discharged from the gas discharge head that has multiple gas discharge pores having pore diameters of 1.5 μm or less are inhibited from colliding with each other, so that the bubbles are unlikely to be combined with each other and enlarged before the non-perfectly spherical bubbles become perfectly spherical stable bubbles, and perfectly spherical bubbles which are maintained to have the bubble diameters obtained immediately after the bubbles have been discharged, are made fine while self-contracting. Thus, a large number of nano-order bubbles having bubble diameters of several hundred nm to several nm can be generated.

In order to inhibit collision between non-spherical bubbles having been just discharged from the gas discharge head, the moving directions of the fine bubbles moving in the liquid in random directions by Brownian motion need to be made uniform. Specifically, a liquid flow that contains bubbles having been just discharged from the gas discharge head is formed into a turbulence as in the fine bubble generating method according to the invention of claim 2 and the fine bubble generating apparatus according to the invention of claim 7, a liquid flow that contains bubbles having been just discharged from the gas discharge head is formed in an eddy flow as in the fine bubble generating method according to the invention of claim 3 and the fine bubble generating apparatus according to the invention of claim 8, vibration having an amplitude of 0.1 μm or greater is continuously applied to a stationary liquid that contains bubbles having been just discharged from the gas discharge head as in the fine bubble generating method according to the invention of claim 4 and the fine bubble generating apparatus according to the invention of claim 9, or vibration having an amplitude of 0.1 μm or greater is continuously applied to a liquid flow that contains bubbles having been just discharged from the gas discharge head as in the fine bubble generating method according to the invention of claim 5 and the fine bubble generating apparatus according to the invention of claim 10, to make bubble moving directions uniform in the liquid.

### BRIEF DESCRIPTION OF THE DRAWINGS

FIG. 1 is a schematic diagram illustrating a configuration of a fine bubble generating apparatus according to one embodiment of the present invention;

FIG. 2 is a schematic diagram illustrating a configuration of a fine bubble generating apparatus according to another embodiment of the present invention;

FIG. 3 is a schematic diagram illustrating a configuration of a fine bubble generating apparatus according to another embodiment of the present invention; and

FIG. 4 is a schematic diagram illustrating a configuration of a fine bubble generating apparatus according to another embodiment of the present invention.

### DESCRIPTION OF EMBODIMENTS

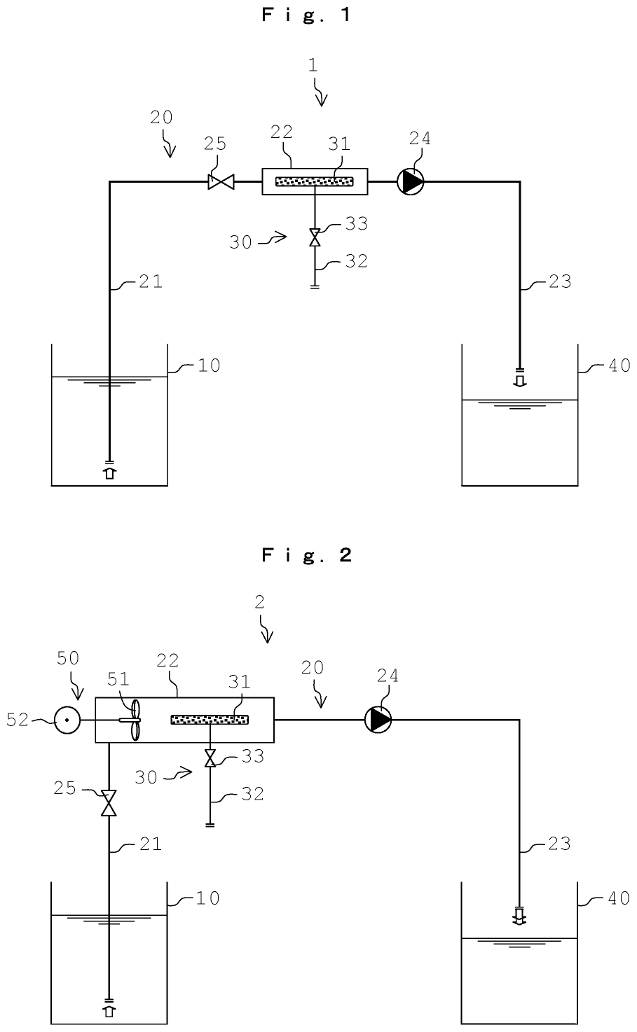

Hereinafter, embodiments will be described with reference to the drawings. FIG. 1 illustrates a schematic configuration of a fine bubble generating apparatus according to the present invention. As shown in FIG. 1, a fine bubble generating apparatus 1 includes a storage tank 10 for storing liquid, a liquid feeding unit 20 for suctioning and feeding the liquid stored in the storage tank 10, a bubble supply unit 30 for supplying bubbles into the liquid which is being fed by the liquid feeding unit 20, and a storage tank 40 for storing the liquid into which bubbles have been supplied by the bubble supply unit 30.

The liquid feeding unit 20 has a liquid flow channel formed by a liquid feeding pipe 21, a bubble supply portion 22, and a liquid feeding pipe 23. The liquid stored in the storage tank 10 is fed through the bubble supply portion 22 into the storage tank 40 by a variable-flow-rate-type liquid feeding pump 24 disposed in the liquid feeding pipe 23 portion. A valve 25 is disposed in the liquid feeding pipe 21 portion, and a negative pressure level in the bubble supply portion 22 can be adjusted by adjusting the opening degree of the valve 25.

The bubble supply unit 30 includes a gas discharge head 31 which is disposed in the bubble supply portion 22 of the liquid feeding unit 20 and which has multiple gas discharge pores having sizes of 1.5 μm or less, and a gas supply pipe 32 and a valve 33 which introduce gas into the gas discharge head 31. Gas is suctioned out through the gas discharge pores of the gas discharge head 31 at a predetermined flow velocity by a suctioning pressure of the liquid feeding pump 24, and is supplied as bubbles into the liquid flowing in the bubble supply portion 21.

As the gas discharge head 31, one of two kinds of Type A and Type B indicated in Table 1 is used. In the gas discharge head of Type A, the average pore diameter of the gas discharge pore is 0.8 μm, the total number of the gas discharge pores is about 20.2×10⁸, and the total area of the all gas discharge pores is 10.18 cm². In the gas discharge head of Type B, the average pore diameter of the gas discharge pore is 0.8 μm, the total number of the gas discharge pores is about 117.2×10⁸, and the total area of the all gas discharge pores is 58.90 cm².

TABLE 1

| | Average pore | | |
|---|---|---|---|
| Gas | diameter of gas | Total number of gas | Total area of gas |
| discharge | discharge pore | discharge pores | discharge pores |
| head | [μm] | [pores] | [cm²] |
| Type A | 0.8 | 20.2 × 10⁸ | 10.18 |
| Type B | 0.8 | 117.2 × 10⁸ | 58.9 |

For the liquid supplied to the bubble supply portion 22, the flow velocity in the bubble supply portion 21 is adjusted such that the liquid flows in a turbulent state in the bubble supply portion 21, and bubbles are supplied into the liquid flow in the turbulent state in the bubble supply portion 21.

The discharge velocity of the gas discharged from each gas discharge pore of the gas discharge head 31 is adjusted so as to satisfy the following formula (1) by adjusting the opening degree of the valve 33 of the bubble supply unit 30. Thus, bubbles having bubble diameters of 1.5 μm or less are supplied into the liquid flow which passes in the bubble supply portion 21.

v_{G}≤0.087×Q_{L}×D_{H}³/A_{H} (1)
v_{G}: gas discharge velocity [m/s] at gas discharge pore of gas discharge head
Q_{L}: liquid flow rate [L/min]
D_{H}: average pore diameter [μm] of gas discharge pore of gas discharge head
A_{H}: total area [cm²] of all gas discharge pores of gas discharge head

Hereinafter, examples 1 to 4 of the present invention and comparative examples 1, 2 in which fine bubbles of air were generated in pure water by using the fine bubble generating apparatus 1 described above, and examples 5 to 8 of the present invention and comparative examples 3, 4 in which fine bubbles of oxygen were generated in kerosene by using the fine bubble generating apparatus 1 described above will be described with reference to Table 2. However, needless to say, the present invention is not limited to the examples described below.

### EXAMPLE 1

As indicated in Table 2, in a room at 20° C., pure water was introduced into the storage tank 10, the liquid feeding pump 24 of the liquid feeding unit 20 was actuated, and air was discharged from the gas discharge head 31 in the bubble supply portion 22 while the pure water in the storage tank 10 was fed to the bubble supply portion 22, whereby bubbles were supplied into the pure water passing through the bubble supply portion 22, and the pure water containing the bubbles was fed into the storage tank 40 and stored. The gas discharge head 31 of Type A was used.

The flow rate of the pure water was 1 L/min, the cross-sectional area of the flow channel at the gas discharge head 31 portion in the bubble supply portion 22 was 0.79 cm², the flow velocity of the pure water was 0.21 m/s, and the pure water flowed in a turbulent state in the bubble supply portion 22. The flow rate of the air was 25 ml/min, and the discharge velocity of the air discharged from each gas discharge pore of the gas discharge head 31 was 0.00041 m/s.

### EXAMPLE 2

As indicated in Table 2, similarly to example 1, bubbles were supplied into pure water passing through the bubble supply portion 22 while the pure water in the storage tank 10 was fed into the bubble supply portion 22, and the pure water containing the bubbles was fed into the storage tank 40 and stored except that the flow rate of the pure water was 1.5 L/min and the flow rate of air was 35 ml/min. The flow velocity of the pure water at the gas discharge head 31 portion in the bubble supply portion 22 was 0.32 m/s, and the pure water flowed in a turbulent state in the bubble supply portion 22. The discharge velocity of the air from each gas discharge pore of the gas discharge head 31 was 0.00057 m/s.5

### EXAMPLE 3

As indicated in Table 2, similarly to example 1, bubbles were supplied into pure water passing through the bubble supply portion 22 while the pure water in the storage tank 10 was fed into the bubble supply portion 22, and the pure water containing the bubbles was fed into the storage tank 40 and stored except that the gas discharge head 31 of Type B was used, the cross-sectional area of the flow channel at the gas discharge head 31 portion in the bubble supply portion 22 was 5 cm², the flow rate of the pure water was 7 L/min, and the flow rate of air was 160 ml/min. The flow velocity of the pure water at the gas discharge head 31 portion in the bubble supply portion 22 was 0.23 m/s, and the pure water flowed in a turbulent state in the bubble supply portion 22. The discharge velocity of the air from each gas discharge pore of the gas discharge head 31 was 0.00045 m/s.

### EXAMPLE 4

As indicated in Table 2, similarly to example 3, bubbles were supplied into pure water passing through the bubble supply portion 22 while the pure water in the storage tank 10 was fed into the bubble supply portion 22, and the pure water containing the bubbles was fed into the storage tank 40 and stored except that the flow rate of the pure water was 12 L/min and the flow rate of air was 300 ml/min. The flow velocity of the pure water in the gas discharge head 31 portion in the bubble supply portion 22 was 0.40 m/s, and the pure water flowed in a turbulent state in the bubble supply portion 22. The discharge velocity of the air from each gas discharge pore of the gas discharge head 31 was 0.00085 m/s.

### EXAMPLE 5

As indicated in Table 2, similarly to example 1, bubbles were supplied into kerosene passing through the bubble supply portion 22 while the kerosene in the storage tank 10 was fed into the bubble supply portion 22, and the kerosene containing the bubbles was fed into the storage tank 40 and stored except that kerosene was used instead of pure water, oxygen was used instead of air, a flow rate of the kerosene was 5 L/min, and the flow rate of the oxygen was 120 ml/min. The flow velocity of the kerosene at the gas discharge head 31 portion in the bubble supply portion 22 was 1.05 m/s, and the kerosene flowed in a turbulent state in the bubble supply portion 22. The discharge velocity of the oxygen from each gas discharge pore of the gas discharge head 31 was 0.00196 m/s.

### EXAMPLE 6

As indicated in Table 2, similarly to example 5, bubbles were supplied into kerosene passing through the bubble supply portion 22 while the kerosene in the storage tank 10 was fed into the bubble supply portion 22, and the kerosene containing the bubbles was fed into the storage tank 40 and stored except that the flow rate of the kerosene was 9 L/min and the flow rate of oxygen was 220 ml/min. The flow velocity of the kerosene at the gas discharge head 31 portion in the bubble supply portion 22 was 1.90 m/s, and the kerosene flowed in a turbulent state in the bubble supply portion 22. The discharge velocity of the oxygen from each gas discharge pore of the gas discharge head 31 was 0.00360 m/s.

### EXAMPLE 7

As indicated in Table 2, similarly to example 3, bubbles were supplied into kerosene passing through the bubble supply portion 22 while the kerosene in the storage tank 10 was fed into the bubble supply portion 22, and the kerosene containing the bubbles was fed into the storage tank 40 and stored except that kerosene was used instead of pure water, oxygen was used instead of air, the flow rate of the kerosene was 13 L/min, and the flow rate of the oxygen was 320 ml/min. The flow velocity of the kerosene at the gas discharge head 31 portion in the bubble supply portion 22 was 0.43 m/s, and the kerosene flowed in a turbulent state in the bubble supply portion 22. The discharge velocity of the oxygen from each gas discharge pore of the gas discharge head 31 was 0.00091 m/s.

### EXAMPLE 8

As indicated in Table 2, similarly to example 7, bubbles were supplied into kerosene passing through the bubble supply portion 22 while the kerosene in the storage tank 10 was fed into the bubble supply portion 22, and the kerosene containing the bubbles was fed into the storage tank 40 and stored except that the flow rate of the kerosene was 22 L/min and the flow rate of oxygen was 530 ml/min. The flow velocity of the kerosene at the gas discharge head 31 portion in the bubble supply portion 22 was 0.73 m/s, and the kerosene flowed in a turbulent state in the bubble supply portion 22. The discharge velocity of the oxygen from each gas discharge pore of the gas discharge head 31 was 0.00150 m/s.

### COMPARATIVE EXAMPLE 1

As indicated in Table 2, similarly to example 1, bubbles were supplied into pure water passing through the bubble supply portion 22 while the pure water in the storage tank 10 was fed into the bubble supply portion 22, and the pure water containing the bubbles was fed into the storage tank 40 and stored except that the flow rate of the pure water was 0.8 L/min and the flow rate of air was 20 ml/min. The flow velocity of the pure water at the gas discharge head 31 portion in the bubble supply portion 22 was 0.17 m/s, and the pure water flowed in a laminar flow state in the bubble supply portion 22. The discharge velocity of the air from each gas discharge pore of the gas discharge head 31 was 0.00033 m/s.

### COMPARATIVE EXAMPLE 2

As indicated in Table 2, similarly to example 3, bubbles were supplied into pure water passing through the bubble supply portion 22 while the pure water in the storage tank 10 was fed into the bubble supply portion 22, and the pure water containing the bubbles was fed into the storage tank 40 and stored except that the flow rate of the pure water was 6 L/min and the flow rate of air was 150 ml/min. The flow velocity of the pure water at the gas discharge head 31 portion in the bubble supply portion 22 was 0.20 m/s, and the pure water flowed in a laminar flow state in the bubble supply portion 22. The discharge velocity of the air from each gas discharge pore of the gas discharge head 31 was 0.00042 m/s.

### COMPARATIVE EXAMPLE 3

As indicated in Table 2, similarly to example 5, bubbles were supplied into kerosene passing through the bubble supply portion 22 while the kerosene in the storage tank 10 was fed into the bubble supply portion 22, and the kerosene containing the bubbles was fed into the storage tank 40 and stored except that the flow rate of the kerosene was 4 L/min and the flow rate of oxygen was 100 ml/min. The flow velocity of the kerosene at the gas discharge head 31 portion in the bubble supply portion 22 was 0.84 m/s, and the kerosene flowed in a laminar flow state in the bubble supply portion 22. The discharge velocity of the oxygen from each gas discharge pore of the gas discharge head 31 was 0.00164 m/s.

### COMPARATIVE EXAMPLE 4

As indicated in Table 2, similarly to example 7, bubbles were supplied into kerosene passing through the bubble supply portion 22 while the kerosene in the storage tank 10 was fed into the bubble supply portion 22, and the kerosene containing the bubbles was fed into the storage tank 40 and stored except that the flow rate of the kerosene was 12 L/min and the flow rate of oxygen was 280 ml/min. The flow velocity of the kerosene at the gas discharge head 31 portion in the bubble supply portion 22 was 0.40 m/s, and the kerosene flowed in a laminar flow state in the bubble supply portion 22. The discharge velocity of the oxygen from each gas discharge pore of the gas discharge head 31 was 0.00079 m/s.

TABLE 2

| | | Cross-sectional | Flow | Flow | | Flow | | Upper limit |
|---|---|---|---|---|---|---|---|---|
| | Gas | area of liquid | rate of | velocity of | Flow rate | velocity of | | value of gas |
| | discharge | flow channel | liquid | liquid | of gas | gas | Liquid flow | flow velocity |
| | head | [cm²] | [L/min] | [m/s] | [ml/min] | [m/s] | (state) | [m/s] |
| Example 1 | Type A | 0.79 | 1 | 0.21 | 25 | 0.00041 | turbulent | 0.0044 |
| Example 2 | Type A | 0.79 | 1.5 | 0.32 | 35 | 0.00057 | turbulent | 0.0066 |
| Example 3 | Type B | 5.00 | 7 | 0.23 | 160 | 0.00045 | turbulent | 0.0053 |
| Example 4 | Type B | 5.00 | 12 | 0.40 | 300 | 0.00085 | turbulent | 0.0091 |
| Example 5 | Type A | 0.79 | 5 | 1.05 | 120 | 0.00196 | turbulent | 0.0219 |
| Example 6 | Type A | 0.79 | 9 | 1.90 | 220 | 0.00360 | turbulent | 0.0394 |
| Example 7 | Type B | 5.00 | 13 | 0.43 | 320 | 0.00091 | turbulent | 0.0098 |
| Example 8 | Type B | 5.00 | 22 | 0.73 | 530 | 0.00150 | turbulent | 0.0166 |
| Comp. Ex. 1 | Type A | 0.79 | 0.8 | 0.17 | 20 | 0.00033 | laminar flow | 0.0035 |
| Comp. Ex. 2 | Type B | 5.00 | 6 | 0.20 | 150 | 0.00042 | laminar flow | 0.0045 |
| Comp. Ex. 3 | Type A | 0.79 | 4 | 0.84 | 100 | 0.00164 | laminar flow | 0.0175 |
| Comp. Ex. 4 | Type B | 5.00 | 12 | 0.40 | 280 | 0.00079 | laminar flow | 0.0091 |

*The upper limit value of the flow velocity of gas is a gas discharge velocity v_{g} calculated according to formula (1).

FIG. 2 illustrates a schematic configuration of a fine bubble generating apparatus according to another embodiment of the present invention. As shown in FIG. 2, the fine bubble generating apparatus 2 has the storage tank 10, the liquid feeding unit 20, the bubble supply unit 30, and the storage tank 40 that are the same as those of the fine bubble generating apparatus 1 described above. Therefore, the same components therebetween are denoted by the same reference numerals and the description thereof is omitted. Different components will be described in detail.

In the bubble supply portion 22 of the liquid feeding unit 20, an eddy flow forming unit 50 for forming the liquid flow in the bubble supply portion 22 into an eddy flow is disposed upstream of the gas discharge head 31 of the bubble supply unit 30. In the bubble supply portion 22, bubbles are supplied into the liquid flow formed into the eddy flow.

The eddy flow forming unit 50 includes a screw propeller 51 disposed so as to be rotatable in the bubble supply portion 22 and a driving motor 52 for rotating the screw propeller 51. The driving motor 52 can adjust the number of revolutions of the screw propeller 51.

Also in the fine bubble generating apparatus 2, the discharge velocity is adjusted so as to satisfy the formula (1) described above by adjusting the opening degree of the valve 33 of the bubble supply unit 30. Thus, bubbles having bubble diameters of 1.5 μm or less are supplied into the liquid flow that passes in the bubble supply portion 22.

Hereinafter, examples 9 to 11 of the present invention and comparative example 5 in which fine bubbles of air were generated in pure water by using the fine bubble generating apparatus 2 described above will be described with reference to Table 3. However, needless to say, the present invention is not limited to the examples described below.

### EXAMPLE 9

As indicated in Table 3, in a room at 20° C., pure water was introduced into the storage tank 10, the liquid feeding pump 24 of the liquid feeding unit 20 was actuated, and air was discharged from the gas discharge head 31 in the bubble supply portion 22 while the pure water in the storage tank 10 was fed into the bubble supply portion 22 and the screw propeller 51 was rotated by actuation of the driving motor 52 of the eddy flow forming unit 50, whereby bubbles were supplied into the pure water passing through the bubble supply portion 22, and the pure water containing the bubbles was fed into the storage tank 40 and stored. The gas discharge head 31 of Type A was used.

The flow rate of the pure water was 2 L/min, the cross-sectional area of the flow channel at the gas discharge head 31 portion in the bubble supply portion 22 was 0.79 cm², the flow velocity of the pure water was 0.42 m/s, the number of revolutions of the screw propeller 51 was 100 rpm, and the pure water flowed in an eddy flow state in the bubble supply portion 22. The flow rate of the air was 45 ml/min, and the discharge velocity of the air discharged from each gas discharge pore of the gas discharge head 31 was 0.00074 m/s.

### EXAMPLE 10

As indicated in Table 3, similarly to example 9, bubbles were supplied into pure water passing through the bubble supply portion 22 while the pure water in the storage tank 10 was fed into the bubble supply portion 22 and the screw propeller 51 was rotated, and the pure water containing the bubbles was fed into the storage tank 40 and stored except that the number of revolutions of the screw propeller 51 was 60 rpm. Therefore, the flow rate of the pure water, the flow velocity of the pure water at the gas discharge head 31 portion in the bubble supply portion 22, the flow rate of air, and the discharge velocity of the air from each gas discharge pore were the same as those in example 9, and the pure water flowed in an eddy flow state in the bubble supply portion 22.

### EXAMPLE 11

As indicated in Table 3, similarly to example 9, bubbles were supplied into pure water passing through the bubble supply portion 22 while the pure water in the storage tank 10 was fed into the bubble supply portion 22 and the screw propeller 51 was rotated, and the pure water containing the bubbles was fed into the storage tank 40 and stored except that the number of revolutions of the screw propeller 51 was 50 rpm. Therefore, the flow rate of the pure water, the flow velocity of the pure water at the gas discharge head 31 portion in the bubble supply portion 22, the flow rate of air, and the discharge velocity of the air from each gas discharge pore are the same as those in example 9, and the pure water flowed in an eddy flow state in the bubble supply portion 22.

### COMPARATIVE EXAMPLE 5

As indicated in Table 3, similarly to example 9, bubbles were supplied into pure water passing through the bubble supply portion 22 while the pure water in the storage tank 10 was fed to the bubble supply portion 22, and the pure water containing the bubbles was fed into the storage tank 40 and stored except that the screw propeller 51 was not rotated. Therefore, the flow rate of the pure water, the flow velocity of the pure water at the gas discharge head 31 portion in the bubble supply portion 22, the flow rate of air, and the discharge velocity of the air from each gas discharge pore were the same as those in example 9. However, the pure water flowed in a laminar flow state in the bubble supply portion 22.

TABLE 3

| | | The number of | Cross-sectional | Flow | Flow | Flow | Flow | | Upper limit |
|---|---|---|---|---|---|---|---|---|---|
| | Gas | revolutions | area of liquid | rate of | velocity | rate of | velocity of | | value of gas |
| | discharge | of propeller | flow channel | liquid | of liquid | gas | gas | Liquid flow | flow velocity |
| | head | [rpm] | [cm²] | [L/min] | [m/s] | [ml/min] | [m/s] | (state) | [m/s] |
| Example 9 | Type A | 100 | 0.79 | 2 | 0.42 | 45 | 0.00074 | eddy flow | 0.0088 |
| Example 10 | Type A | 60 | 0.79 | 2 | 0.42 | 45 | 0.00074 | eddy flow | 0.0088 |
| Example 11 | Type A | 50 | 0.79 | 2 | 0.42 | 45 | 0.00074 | eddy flow | 0.0088 |
| Comp. Ex. 5 | Type A | — | 0.79 | 2 | 0.42 | 45 | 0.00074 | laminar flow | 0.0088 |

*The upper limit value of the flow velocity of gas is a gas discharge velocity v_{g} calculated according to formula (1).

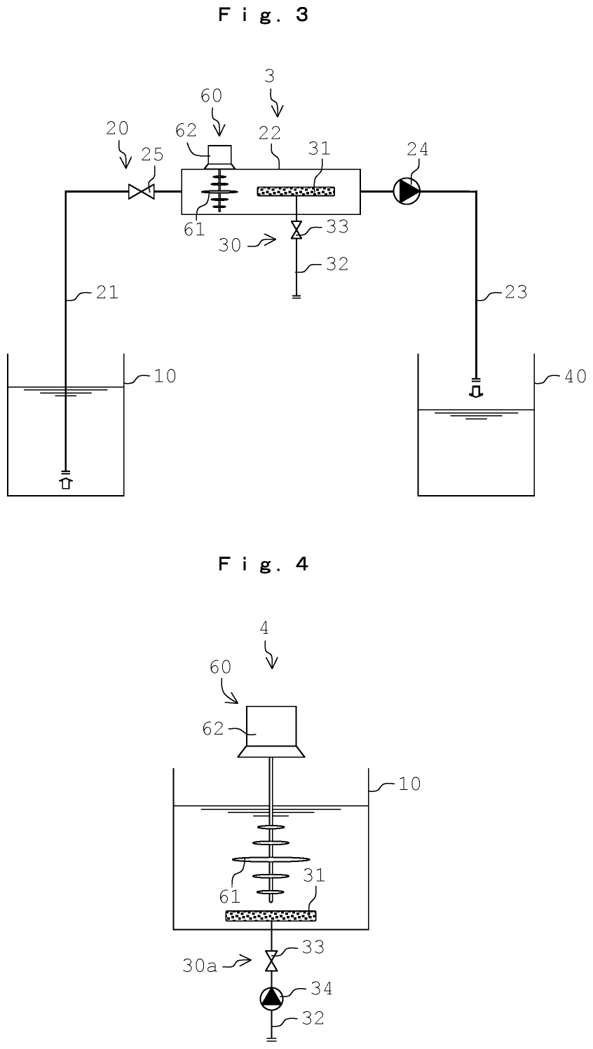

FIG. 3 illustrates a schematic configuration of a fine bubble generating apparatus according to another embodiment of the present invention. As shown in FIG. 3, a fine bubble generating apparatus 3 includes the storage tank 10, the liquid feeding unit 20, the bubble supply unit 30, and the storage tank 40 that are the same as those of the fine bubble generating apparatus 1 described above. Therefore, the same components therebetween are denoted by the same reference numerals and the description thereof is omitted. Different components will be described in detail.

In the bubble supply portion 22 of the liquid feeding unit 20, a vibration applying unit 60 for continuously applying vibration having an amplitude of 0.1 μm or greater to the liquid flow in the bubble supply portion 22 is disposed upstream of the gas discharge head 31 of the bubble supply unit 30. In the bubble supply portion 22, bubbles are supplied into the liquid flow to which the vibration having an amplitude of 0.1 μm or greater has been applied.

The vibration applying unit 60 includes a vibration blade 61 disposed in the bubble supply portion 22, a vibrator 62 that transmits vibration to the vibration blade 61, and a not-illustrated high frequency conversion circuit. As the vibrator 62, a Langevin transducer that holds two piezoelectric elements between two metal blocks is adopted.

Also in the fine bubble generating apparatus 3, the discharge velocity is adjusted so as to satisfy the formula (1) described above by adjusting the opening degree of the valve 33 of the bubble supply unit 30. Thus, bubbles having bubble diameters of 1.5 μm or less are supplied into the liquid flow that passes in the bubble supply portion 22.

Hereinafter, examples 12 to 15 of the present invention and comparative examples 6, 7 in which fine bubbles of air were generated in pure water by using the fine bubble generating apparatus 3 described above will be described with reference to Table 4. However, needless to say, the present invention is not limited to the examples described below.

### EXAMPLE 12

As indicated in Table 4, in a room at 20° C., pure water was introduced into the storage tank 10, the liquid feeding pump 24 of the liquid feeding unit 20 was actuated, and air was discharged from the gas discharge head 31 in the bubble supply portion 22 while the pure water in the storage tank 10 was fed into the bubble supply portion 22 and vibration having a vibration frequency of 25 kHz and an amplitude of 0.1 μm was continuously applied to the pure water passing in the bubble supply portion 22, whereby bubbles were supplied into the pure water passing through the bubble supply portion 22, and the pure water containing the bubbles was fed into the storage tank 40 and stored. The gas discharge head 31 of Type A was used.

The flow rate of the pure water was 2 L/min, the cross-sectional area of the flow channel at the gas discharge head 31 portion in the bubble supply portion 22 was 0.79 cm², the flow velocity of the pure water was 0.42 m/s, and the pure water flowed in a laminar flow state in the bubble supply portion 22. The flow rate of the air was 45 ml/min, and the discharge velocity of the air discharged from each gas discharge pore of the gas discharge head 31 was 0.00074 m/s.

### EXAMPLE 13

As indicated in Table 4, similarly to example 12, bubbles were supplied into pure water passing in the bubble supply portion 22 while the pure water in the storage tank 10 was fed into the bubble supply portion 22 and vibration was continuously applied to the pure water passing in the bubble supply portion 22, and the pure water containing the bubbles was fed into the storage tank 40 and stored except that vibration having a vibration frequency of 40 kHz and an amplitude of 0.1 μm was continuously applied to the pure water passing in the bubble supply portion 22. Therefore, the flow rate of the pure water, the flow velocity of the pure water at the gas discharge head 31 portion in the bubble supply portion 22, the flow rate of air, and the discharge velocity of the air from each gas discharge pore were the same as those in example 12, and the pure water flowed in a laminar flow state in the bubble supply portion 22.

### Example 14

As indicated in Table 4, similarly to example 12, bubbles were supplied into pure water passing in the bubble supply portion 22 while the pure water in the storage tank 10 was fed into the bubble supply portion 22 and vibration was continuously applied to the pure water passing in the bubble supply portion 22, and the pure water containing the bubbles was fed into the storage tank 40 and stored except that vibration having a vibration frequency of 100 kHz and an amplitude of 0.1 μm was continuously applied to the pure water passing in the bubble supply portion 22. Therefore, the flow rate of the pure water, the flow velocity of the pure water at the gas discharge head 31 portion in the bubble supply portion 22, the flow rate of air, and the discharge velocity of the air from each gas discharge pore were the same as those in example 12, and the pure water flowed in a laminar flow state in the bubble supply portion 22.

### EXAMPLE 15

As indicated in Table 4, similarly to example 12, bubbles were supplied into pure water passing in the bubble supply portion 22 while the pure water in the storage tank 10 was fed into the bubble supply portion 22 and vibration was continuously applied to the pure water passing in the bubble supply portion 22, and the pure water containing the bubbles was fed into the storage tank 40 and stored except that vibration having a vibration frequency of 1000 kHz and an amplitude of 0.1 μm was continuously applied to the pure water passing in the bubble supply portion 22. Therefore, the flow rate of the pure water, the flow velocity of the pure water at the gas discharge head 31 portion in the bubble supply portion 22, the flow rate of air, and the discharge velocity of the air from each gas discharge pore were the same as those in example 12, and the pure water flowed in a laminar flow state in the bubble supply portion 22.

### COMPARATIVE EXAMPLE 6

As indicated in Table 4, similarly to example 12, bubbles were supplied into pure water passing in the bubble supply portion 22 while the pure water in the storage tank 10 was fed into the bubble supply portion 22 and vibration was continuously applied to the pure water passing in the bubble supply portion 22, and the pure water containing the bubbles was fed into the storage tank 40 and stored except that vibration having a vibration frequency of 40 kHz and an amplitude of 0.05 μm was continuously applied to the pure water passing in the bubble supply portion 22. Therefore, the flow rate of the pure water, the flow velocity of the pure water at the gas discharge head 31 portion in the bubble supply portion 22, the flow rate of air, and the discharge velocity of the air from each gas discharge pore were the same as those in example 12, and the pure water flowed in a laminar flow state in the bubble supply portion 22.

### COMPARATIVE EXAMPLE 7

As indicated in Table 4, similarly to example 12, bubbles were supplied into pure water passing in the bubble supply portion 22 while the pure water in the storage tank 10 was fed into the bubble supply portion 22, and the pure water containing the bubbles was fed into the storage tank 40 and stored except that no vibration was applied to the pure water passing in the bubble supply portion 22. Therefore, the flow rate of the pure water, the flow velocity of the pure water at the gas discharge head 31 portion in the bubble supply portion 22, the flow rate of air, and the discharge velocity of the air from each gas discharge pore were the same as those in example 12, and the pure water flowed in a laminar flow state in the bubble supply portion 22.

TABLE 4

| | | Cross-sectional | Flow | Flow | Flow | Flow | | | | Upper limit |
|---|---|---|---|---|---|---|---|---|---|---|
| | Gas | area of liquid | rate of | velocity | rate of | velocity | Vibration | | | value of gas |
| | discharge | flow channel | liquid | of liquid | gas | of gas | frequency | Amplitude | Liquid flow | flow velocity |
| | head | [cm²] | [L/min] | [m/s] | [ml/min] | [m/s] | [kHz] | [μm] | (state) | [m/s] |
| Example 12 | Type A | 0.79 | 2 | 0.42 | 45 | 0.00074 | 25 | 0.10 | laminar flow | 0.0088 |
| Example 13 | Type A | 0.79 | 2 | 0.42 | 45 | 0.00074 | 40 | 0.10 | laminar flow | 0.0088 |
| Example 14 | Type A | 0.79 | 2 | 0.42 | 45 | 0.00074 | 100 | 0.10 | laminar flow | 0.0088 |
| Example 15 | Type A | 0.79 | 2 | 0.42 | 45 | 0.00074 | 1000 | 0.10 | laminar flow | 0.0088 |
| Comp. Ex. 6 | Type A | 0.79 | 2 | 0.42 | 45 | 0.00074 | 40 | 0.05 | laminar flow | 0.0088 |
| Comp. Ex. 7 | Type A | 0.79 | 2 | 0.42 | 45 | 0.00074 | — | — | laminar flow | 0.0088 |

*The upper limit value of the flow velocity of gas is a gas discharge velocity v_{g} calculated according to formula (1).

FIG. 4 illustrates a schematic configuration of a fine bubble generating apparatus according to another embodiment of the present invention. As shown in FIG. 4, a fine bubble generating apparatus 4 includes the storage tank 10 for storing liquid, a bubble supply unit 30a for supplying bubbles into the liquid stored in the storage tank 10, and the vibration applying unit 60 for continuously applying, to the liquid in the storage tank 10, vibration having an amplitude of 0.1 μm or greater. The fine bubble generating apparatus 4 supplies bubbles into the liquid while continuously applying vibration to the liquid stored in the storage tank 10.

The bubble supply unit 30a includes the gas discharge head 31 which has multiple gas discharge pores having sizes of 1.5 μm or less and which is immersed in the liquid stored in the storage tank 10, and the gas supply pipe 32 and a variable-flow-rate-type gas supply pump 34 for introducing gas into the gas discharge head 31. The discharge velocity of gas discharged from each gas discharge pore of the gas discharge head 31 is adjusted so as to satisfy the following formula (2) by adjusting a discharge rate of the gas supply pump 34. Thus, bubbles having bubble diameters of 1.5 μm or less are supplied into the liquid stored in the storage tank 10.

v_{G}≤0.087×V_{L}/t×D_{H}³/A_{H} (2)
v_{G}: gas discharge velocity [m/s] at gas discharge pore of gas discharge head
V_{L}: liquid amount [L]
t: operation time (time when gas is discharged from gas discharge pore of gas discharge head) [s]
D_{H}: average pore diameter [μm] of gas discharge pore of gas discharge head
A_{H}: total area [cm²] of all gas discharge pores of gas discharge head

The vibration applying unit 60 includes the vibration blade 61 which is immersed in the liquid stored in the storage tank 10, the vibrator 62 that transmits vibration to the vibration blade 61, and a not-illustrated high frequency conversion circuit. As the vibrator 62, a Langevin transducer that holds two piezoelectric elements between two metal blocks is adopted.

Hereinafter, examples 16 to 19 of the present invention and comparative examples 8, 9 in which fine bubbles of air were generated in pure water by using the fine bubble generating apparatus 4 described above will be described with reference to Table 5. However, needless to say, the present invention is not limited to the examples described below.

### EXAMPLE 16

As indicated in Table 5, in a room at 20° C., 1 L of pure water was introduced into the storage tank 10, and bubbles were supplied into the pure water for one minute by using the bubble supply unit 30a while vibration having a vibration frequency of 25 kHz and an amplitude of 0.1 μm was applied to the pure water by the vibration applying unit 60. The gas discharge head 31 of Type A was used. The flow rate of air was 25 ml/min, and the discharge velocity of the air discharged from each gas discharge pore of the gas discharge head 31 was 0.00041 m/s.

### EXAMPLE 17

As indicated in Table 5, similarly to example 16, while vibration was applied to 1 L of pure water introduced into the storage tank 10 by the vibration applying unit 60, bubbles were supplied into the pure water for one minute by using the bubble supply unit 30a except that vibration having a vibration frequency of 40 kHz and an amplitude of 0.1 μm was applied to the pure water in the storage tank 10. Therefore, the flow rate of air and the discharge velocity of the air from each gas discharge pore were the same as those in example 16.

### EXAMPLE 18

As indicated in Table 5, similarly to example 16, while vibration was applied to 1 L of pure water introduced into the storage tank 10 by the vibration applying unit 60, bubbles were supplied into the pure water for one minute by using the bubble supply unit 30a except that vibration having a vibration frequency of 100 kHz and an amplitude of 0.1 μm was applied to the pure water in the storage tank 10. Therefore, the flow rate of air and the discharge velocity of the air from each gas discharge pore were the same as those in example 16.

### EXAMPLE 19

As indicated in Table 5, similarly to example 16, while vibration was applied to 1 L of pure water introduced into the storage tank 10 by the vibration applying unit 60, bubbles were supplied into the pure water for one minute by using the bubble supply unit 30a except that vibration having a vibration frequency of 1000 kHz and an amplitude of 0.1 μm was applied to the pure water in the storage tank 10. Therefore, the flow rate of air and the discharge velocity of the air from each gas discharge pore were the same as those in example 16.

### COMPARATIVE EXAMPLE 8

As indicated in Table 5, similarly to example 16, while vibration was applied to 1 L of pure water introduced into the storage tank 10 by the vibration applying unit 60, bubbles were supplied into the pure water for one minute by using the bubble supply unit 30a except that vibration having a vibration frequency of 40 kHz and an amplitude of 0.05 μm was applied to the pure water in the storage tank 10. Therefore, the flow rate of air and the discharge velocity of the air from each gas discharge pore were the same as those in example 16.

### COMPARATIVE EXAMPLE 9

As indicated in Table 5, similarly to example 16, bubbles were supplied into 1 L of pure water introduced into the storage tank 10 for one minute by using the bubble supply unit 30a except that no vibration was applied to the pure water in the storage tank 10. Therefore, the flow rate of air and the discharge velocity of the air from each gas discharge pore were the same as those in example 16.

TABLE 5

| | | | Flow | Flow | | | | Upper limit |
|---|---|---|---|---|---|---|---|---|
| | Gas | Liquid | rate of | velocity | Vibration | | Operation | value of gas |
| | discharge | amount | gas | of gas | frequency | Amplitude | time | flow velocity |
| | head | [L] | [ml/min] | [m/s] | [kHz] | [μm] | [min] | [m/s] |
| Example 16 | Type A | 1 | 25 | 0.00041 | 25 | 0.10 | 1 | 0.0044 |
| Example 17 | Type A | 1 | 25 | 0.00041 | 40 | 0.10 | 1 | 0.0044 |
| Example 18 | Type A | 1 | 25 | 0.00041 | 100 | 0.10 | 1 | 0.0044 |
| Example 19 | Type A | 1 | 25 | 0.00041 | 1000 | 0.10 | 1 | 0.0044 |
| Comp. Ex. 8 | Type A | 1 | 25 | 0.00041 | 40 | 0.05 | 1 | 0.0044 |
| Comp. Ex. 9 | Type A | 1 | 25 | 0.00041 | — | — | 1 | 0.0044 |

*The upper limit value of the flow velocity of gas is a gas discharge velocity v_{g} calculated according to formula (2).

As to the average diameter and the number of bubbles contained in the liquid generated according to each of examples 1 to 19 and comparative examples 1 to 9 described above, fine bubbles having sizes of 200 nm or less were measured by using a nanoparticle analyzing system (NanoSight NS300 manufactured by Spectris PLC in the U.K.) and the results are indicated in Table 6.

TABLE 6

| | Average diameter of | The number of |
|---|---|---|
| | generated bubbles | generated bubbles |
| | [nm] | [bubbles/ml] |
| Example 1 | 98 | 1.4 × 10⁸ |
| Example 2 | 102 | 7.6 × 10⁹ |
| Example 3 | 101 | 3.2 × 10⁸ |
| Example 4 | 108 | 2.8 × 10⁹ |
| Example 5 | 110 | 6.3 × 10⁷ |
| Example 6 | 112 | 8.5 × 10⁸ |
| Example 7 | 105 | 9.1 × 10⁷ |
| Example 8 | 120 | 8.2 × 10⁸ |
| Example 9 | 105 | 2.4 × 10⁸ |
| Example 10 | 106 | 1.2 × 10⁶ |
| Example 11 | 103 | 3.5 × 10⁵ |
| Example 12 | 112 | 2.4 × 10⁸ |
| Example 13 | 108 | 3.8 × 10⁸ |
| Example 14 | 114 | 1.5 × 10⁸ |
| Example 15 | 106 | 9.1 × 10⁷ |
| Example 16 | 103 | 5.6 × 10⁹ |
| Example 17 | 99 | 2.4 × 10⁹ |
| Example 18 | 96 | 8.2 × 10⁸ |
| Example 19 | 101 | 5.1 × 10⁸ |
| Comp. Ex. 1 | — | — |
| Comp. Ex. 2 | — | — |
| Comp. Ex. 3 | — | — |
| Comp. Ex. 4 | — | — |
| Comp. Ex. 5 | — | — |
| Comp. Ex. 6 | — | — |
| Comp. Ex. 7 | — | — |
| Comp. Ex. 8 | — | — |
| Comp. Ex. 9 | — | — |

As is apparent from Table 6, in examples 1 to 8 in which bubbles ware supplied into the liquid flow in a turbulent state by discharging gas from the gas discharge pores having an average pore diameter of 0.8 μm in the gas discharge head 31 at a gas discharge velocity which was not greater than the upper limit value of the gas flow velocity calculated according to the formula (1), in examples 9 to 11 in which bubbles were supplied into the liquid flow in an eddy flow state by discharging gas from the gas discharge pores having an average pore diameter of 0.8 μm in the gas discharge head 31 at a gas discharge velocity which was not greater than the upper limit value of the gas flow velocity calculated according to formula (1), in examples 12 to 15 in which bubbles were supplied into the liquid flow in a laminar flow state by discharging gas from the gas discharge pores having an average pore diameter of 0.8 μm in the gas discharge head 31 at the gas discharge velocity which was not greater than the upper limit value of the gas flow velocity calculated according to formula (1) while vibration having an amplitude of 0.1 μm or greater was continuously applied, and in examples 16 to 19 in which bubbles were supplied into stationary liquid by discharging gas from the gas discharge pores having an average pore diameter of 0.8 μm in the gas discharge head 31 at the gas discharge velocity which was not greater than the upper limit value of the gas flow velocity calculated according to the formula (2) while vibration having an amplitude of 0.1 μm or greater was continuously applied, it was confirmed that the number of fine bubbles having an average bubble diameter of around 100 nm was 3.5×10⁵ to 7.6×10⁹ in 1 ml of the obtained liquid.

Meanwhile, in comparative examples 1 to 5 in which the discharge velocity of the gas discharged from the gas discharge pores having an average pore diameter of 0.8 μm in the gas discharge head 31 was not greater than the upper limit value of the gas flow velocity calculated according to formula (1) but bubbles were supplied into the liquid flow in a laminar flow state, in comparative example 6 in which the discharge velocity of the gas discharged from the gas discharge pores having an average pore diameter of 0.8 μm in the gas discharge head 31 was not greater than the upper limit value of the gas flow velocity calculated according to the formula (1) but bubbles were supplied into the liquid flow in a laminar flow state while vibration having an amplitude of less than 0.1 μm was applied, in comparative example 7 in which the discharge velocity of the gas discharged from the gas discharge pores having an average pore diameter of 0.8 μm in the gas discharge head 31 was not greater than the upper limit value of the gas flow velocity calculated according to formula (1) but bubbles were supplied into the liquid flow in a laminar flow state without application of vibration, in comparative example 8 in which the discharge velocity of the gas discharged from the gas discharge pores having an average pore diameter of 0.8 μm in the gas discharge head 31 was not greater than the upper limit value of the gas flow velocity calculated according to formula (2) but bubbles were supplied into the stationary liquid while vibration having an amplitude of less than 0.1 μm was applied, and in comparative example 9 in which the discharge velocity of the gas discharged from the gas discharge pores having an average pore diameter of 0.8 μm in the gas discharge head 31 was not greater than the upper limit value of the gas flow velocity calculated according to formula (2) but bubbles were supplied into the stationary liquid without application of vibration, the number of fine bubbles having sizes of 200 nm or less was extremely small in 1 ml of the obtained liquid, and, therefore, the bubble diameters and the number of the fine bubbles having the sizes of 200 nm or less could not be measured by the nanoparticle analyzing system.

As described above, when the liquid flow is formed into a turbulence or an eddy flow, or vibration having an amplitude of 0.1 μm or greater is applied to liquid flow or stationary fluid, non-perfectly spherical bubbles which have bubble diameters of 1.5 μm or less immediately after being discharged from the gas discharge pores having pore diameters of 1.5 μm or less in the gas discharge head 31 are inhibited from colliding with each other, so that the bubbles are unlikely to be combined with each other and enlarged before the non-perfectly spherical bubbles become perfectly spherical stable bubbles, and perfectly spherical bubbles which are maintained to have the bubble diameters, of 1.5 μm or less, which are the same diameters as the bubbles having been just discharged, are made fine while self-contracting. Therefore, fine bubbles having an average bubble diameter of around 100 nm can be efficiently generated.

In examples 9 to 11 in which bubbles were supplied into the liquid flow in an eddy flow state, the greater the number of revolutions of the screw propeller 51 was, the greater the number of fine bubbles generated so as to have an average bubble diameter of around 100 nm was. In example 11 in which the number of revolutions of the screw propeller 51 was 50 rpm, the number of generated fine bubbles was less than 1×10⁶. Therefore, the number of revolutions of the screw propeller 51 is preferably set to be not less than 80 rpm in order to assure that the number of fine bubbles having the average bubble diameter of around 100 nm is not less than 1×10⁶ in 1 ml of liquid.

In each of the examples described above, the gas discharge head 31 which has the gas discharge pores having the average pore diameter of 0.8 μm was used. However, the present invention is not limited thereto, and the gas discharge pore may have an average pore diameter of 1.5 μm or less.

In each of the examples described above, gas was discharged from the gas discharge pores of the gas discharge head 31 at a gas discharge velocity which was about 1/10 of the upper limit value of the gas flow velocity calculated according to formula (1) or formula (2). However, the present invention is not limited thereto as long as the gas discharge velocity is not greater than the upper limit value of the gas flow velocity having been calculated. However, when gas is discharged at a gas discharge velocity which is about 1/10 of the upper limit value of the gas flow velocity having been calculated, fine bubbles having an average bubble diameter of around 100 nm can be most efficiently generated. Therefore, the gas discharge velocity is preferably adjusted to about 1/10 of the upper limit value of the gas flow velocity having been calculated.

In the fine bubble generating apparatuses 1 to 3 described above, in the liquid feeding unit 20, the liquid feeding pump 24 is disposed downstream of the bubble supply portion 22 in which the gas discharge head 31 is disposed such that gas is naturally suctioned into the liquid flow through the gas discharge pores of the gas discharge head 31 by the suctioning pressure of the liquid feeding pump 24. However, the present invention is not limited thereto. The liquid feeding pump 24 may be disposed upstream of the bubble supply portion 22. However, when the liquid feeding pump 24 is disposed upstream of the bubble supply portion 22, the bubble supply unit needs to have a gas supply pump, to push out gas into the liquid flow from the gas discharge pores of the gas discharge head 31 by the discharging pressure of the gas supply pump.

In the fine bubble generating apparatus 2 described above, liquid flow in the bubble supply portion 22 is formed into an eddy flow by rotating the screw propeller 51 disposed upstream of the gas discharge head 31 of the bubble supply unit 30 in the bubble supply portion 22 of the liquid feeding unit 20. However, the present invention is not limited thereto. For example, when a helical guide plate is disposed on the inner circumferential surface of a cylindrical flow channel, liquid flow in the flow channel can be formed into an eddy flow. Thus, various eddy flow generation mechanisms can be adopted.

In the fine bubble generating apparatuses 3 and 4 described above, a Langevin transducer is used as the vibrator 62 of the vibration applying unit 60. However, the present invention is not limited thereto. Various vibrators can be used.

In the fine bubble generating apparatuses 1 to 3 described above, bubbles are supplied into the liquid flow in a turbulent state, the liquid flow in an eddy flow state, and the liquid flow to which vibration having an amplitude of 0.1 μm or greater has been applied. However, the present invention is not limited thereto. The liquid flow to which bubbles have been supplied may be formed into a turbulence or an eddy flow, or vibration having an amplitude of 0.1 μm or greater may be applied to the liquid flow to which bubbles have been supplied.

However, non-perfectly spherical unstable bubbles which have been just generated change into perfectly spherical stable bubbles in a short period of time. Therefore, when the liquid flow to which bubbles have been supplied is formed into a turbulence or an eddy flow, or vibration is applied to the liquid flow to which bubbles have been supplied, the liquid flow needs to be formed into a turbulence or an eddy flow immediately after the bubbles have been supplied, or vibration needs to be applied to the liquid flow immediately after the bubbles have been supplied, so as to prevent the bubbles from colliding with each other.

### INDUSTRIAL APPLICABILITY

The fine bubble generating method and the fine bubble generating apparatus according to the present invention can efficiently generate nano-order fine bubbles of various gases in various liquids, and can thus be used in various fields such as treatment of wastes from plants, cleaning, sterilization, disinfection, maintenance of freshness of perishable products, aquaculture, and the like, by selecting the liquid and the gas to be contained as fine bubbles in the liquid as appropriate.

### DESCRIPTION OF THE REFERENCE CHARACTERS

1, 2, 3, 4 fine bubble generating apparatus

10, 40 storage tank

20 liquid feeding unit

21, 23 liquid feeding pipe

22 bubble supply portion

24 liquid feeding pump

25 valve

30, 30a bubble supply unit

31 gas discharge head

32 gas supply pipe

33 valve

34 gas supply pump

50 eddy flow forming unit

51 screw propeller

52 driving motor

60 vibration applying unit

61 vibration blade

62 vibrator

1. A fine bubble generating method for generating, in liquid, fine bubbles having nano-order diameters, the fine bubble generating method comprising supplying bubbles into the liquid by discharging gas from a gas discharge head that has multiple gas discharge pores having pore diameters of 1.5 μm or less, and inhibiting the bubbles from colliding with each other.

2. The fine bubble generating method according to claim 1, wherein a liquid flow is formed into a turbulence while bubbles are supplied into the liquid flow, or bubbles are supplied into a liquid flow while the liquid flow is formed into a turbulence, to inhibit the bubbles from colliding with each other.

3. The fine bubble generating method according to claim 1, wherein a liquid flow is formed into an eddy flow while bubbles are supplied into the liquid flow, or bubbles are supplied into a liquid flow while the liquid flow is formed into an eddy flow, to inhibit the bubbles from colliding with each other.

4. The fine bubble generating method according to claim 1, wherein bubbles are supplied into a stationary liquid while vibration having an amplitude of 0.1 μm or greater is continuously applied to the stationary liquid, or vibration having an amplitude of 0.1 μm or greater is continuously applied to a stationary liquid while bubbles are supplied into the stationary liquid, to inhibit the bubbles from colliding with each other.

5. The fine bubble generating method according to claim 1, wherein bubbles are supplied into a liquid flow while vibration having an amplitude of 0.1 μm or greater is continuously applied to the liquid flow, or vibration having an amplitude of 0.1 μm or greater is continuously applied to a liquid flow while bubbles are supplied into the liquid flow, to inhibit the bubbles from colliding with each other.

6. A fine bubble generating apparatus for generating, in liquid, fine bubbles having nano-order diameters, the fine bubble generating apparatus comprising:
a bubble supply unit configured to supply bubbles into liquid; and
a bubble collision inhibiting unit configured to inhibit the bubbles supplied into the liquid by the bubble supply unit from colliding with each other, wherein
the bubble supply unit
has a gas discharge head which is immersed in the liquid and has gas discharge pores having sizes of 1.5 μm or less.

7. The fine bubble generating apparatus according to claim 6, wherein
the bubble supply unit supplies bubbles to a liquid flow in a flow channel,
the bubble collision inhibiting unit has a turbulence forming portion that forms the liquid flow in the flow channel into a turbulence, and
the turbulence forming portion forms, while bubbles are supplied into a liquid flow from the gas discharge head, the liquid flow into a turbulence, or bubbles are supplied into a liquid flow from the gas discharge head while the turbulence forming portion forms the liquid flow into a turbulence, to inhibit the bubbles from colliding with each other.

8. The fine bubble generating apparatus according to claim 6, wherein
the bubble supply unit supplies bubbles into a liquid flow in a flow channel,
the bubble collision inhibiting unit has an eddy flow forming portion that forms the liquid flow in the flow channel into an eddy flow, and
the eddy flow forming portion forms, while bubbles are supplied into a liquid flow from the gas discharge head, the liquid flow into an eddy flow, or bubbles are supplied into a liquid flow from the gas discharge head while the eddy flow forming portion forms the liquid flow into an eddy flow, to inhibit the bubbles from colliding with each other.

9. The fine bubble generating apparatus according to claim 6, wherein
the bubble supply unit supplies bubbles into a stationary liquid stored in a storage tank unit,
the bubble collision inhibiting unit has a vibrator for continuously applying vibration having an amplitude of 0.1 μm or greater, to the stationary liquid stored in the storage tank unit, and
the vibrator continuously applies, while bubbles are supplied into a stationary liquid from the gas discharge head, vibration having an amplitude of 0.1 μm or greater to the stationary liquid, or bubbles are supplied into a stationary liquid from the gas discharge head while the vibrator continuously applies vibration having an amplitude of 0.1 μm or greater to the stationary liquid, to inhibit the bubbles from colliding with each other.

10. The fine bubble generating apparatus according to claim 6, wherein
the bubble supply unit supplies bubbles into a liquid flow,
the bubble collision inhibiting unit has a vibrator for continuously applying vibration having an amplitude of 0.1 μm or greater to the liquid flow, and
the vibrator continuously applies, while bubbles are supplied into a liquid flow from the gas discharge head, vibration having an amplitude of 0.1 μm or greater to the liquid flow, or bubbles are supplied into a liquid flow from the gas discharge head while the vibrator continuously applies vibration having an amplitude of 0.1 μm or greater to the liquid flow, to inhibit the bubbles from colliding with each other.
